(19) United States
(12) Patent Application Publication
(10) Pub. No.: US 2015/0091837 A1
(43) Pub. Date: Apr. 2, 2015

(54) Providing Touch Engine Processing Remotely from a Touch Screen

(71) Applicant: Raman M. Srinivasan, Portland, OR (US)

(72) Inventor: Raman M. Srinivasan, Portland, OR (US)

(21) Appl. No.: 14/038,798

(22) Filed: Sep. 27, 2013

(51) Int. Cl. G06F 3/044

(52) U.S. Cl. CPC G06F 3/044
USPC 345/174

(57) ABSTRACT

According to some embodiments, touch screen command processing may be offloaded to a remote processor already provided within the host. For example a graphics processor (or any other processor including a digital signal processor, an accelerator, a manageability engine, a security engine or any other auxiliary processor) may be used to handle these commands at essentially no cost since no additional hardware is generally needed.

### BACKGROUND

This relates generally to the processing of touch commands received through a touch screen.

Typically a touch screen, which may include a display screen or a touch pad, receives user inputs through a stylus or finger contact. Capacitive sensors pick up the commands and use the location of the finger or stylus contact to interpret an input. For example if the user touches an icon on a display screen, that may be interpreted as a selection of that icon.

Generally, touch screen commands are processed by an integrated circuit chip within the touch screen itself. Thus the touch screen inputs are handled wholly within the touch screen and then the resulting commands may be sent on to the host processor and operating system for implementation.

### BRIEF DESCRIPTION OF THE DRAWINGS

Some embodiments are described with respect to the following figures:

FIG. 1 is a schematic depiction of one embodiment;

FIG. 2 is a more detailed depiction of the touch analog to digital converter 18 according to one embodiment;

FIG. 3 is a flow chart for the touch analog to digital converter according to one embodiment;

FIG. 4 is a flow chart for a touch controller according to one embodiment; and

FIG. 5 is a flow chart a remote processing of touch commands.

### DETAILED DESCRIPTION

When touch engine processing is done in an integrated circuit associated with the touch screen, additional costs may be incurred because of the cost of a processing integrated circuit within the touch screen itself. According to some embodiments, touch screen command processing may be offloaded to a remote processor already provided within the host. For example a graphics processor (or any other processor including a digital signal processor, an accelerator, a manageability engine, a security engine or any other auxiliary processor) may be used to handle these commands at essentially no cost since no additional hardware is generally needed.

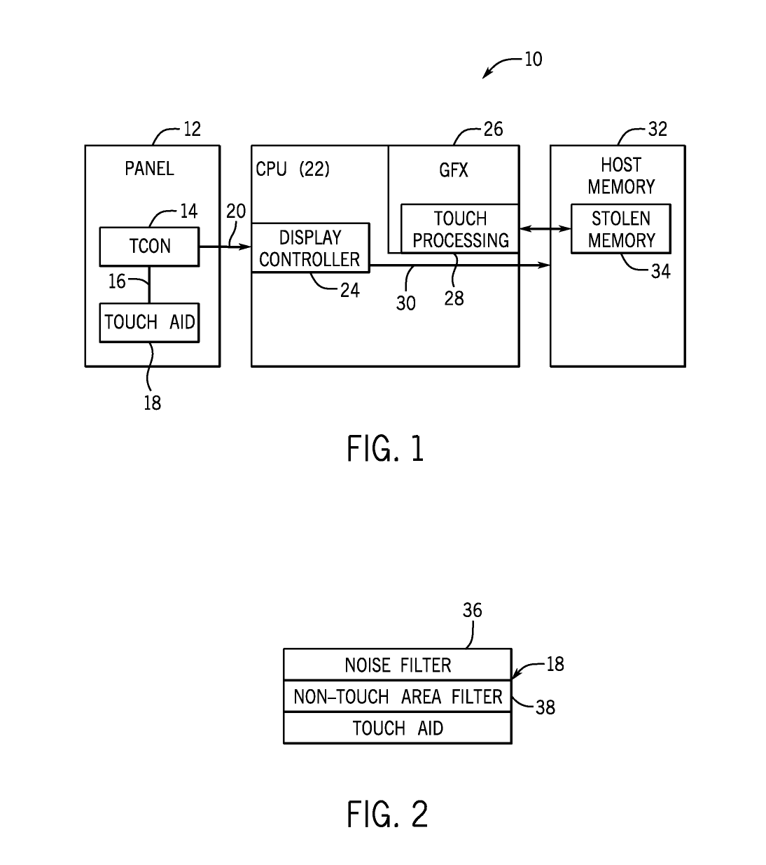

Referring to FIG. 1, according to one embodiment, a platform 10 may have a panel 12 that may be the touch screen. The touch screen or panel includes a touch or timing controller or TCON 14 coupled to a touch analog to digital (A to D) converter 18. The TCON 14 and touch A to D converter 18 may be coupled by a bus 16. In one embodiment the bus may be a serial parallel interface (SPI) or even a higher speed interface.

As shown in FIG. 2, the touch analog to digital converter may include a noise filter 36 for basic noise filtering of the touch data. It may also include a filter 38 that removes non-touch areas from the data in order to provide compression. The touch A to D may provide analog capture and basic touch detection. Alternatively, it may interface through a digital interface that connects to a system on a chip.

The touch analog to digital converter output goes over the bus 16 to the touch controller 14. The touch controller then packetizes the data and places in a form suitable to go over an extended DisplayPort auxiliary channel also, known as an AUX channel. In other embodiments, a fast AUX may be used. Fast AUX can support higher bandwidth to support scaling to multi-touch and may enable sending complete images at a faster scan rate.

DisplayPort is a digital display interface from the Video Electronic Standards Association (VESA). The interface connects the video source to a display device, such as a computer monitor. See DisplayPort Standard 1.2 (December 22, 2009), available from VESA. DisplayPort uses packetized data transmission. Particularly, it uses small data packets called micropackets that can embed the clock signal with the data stream. DisplayPort can transmit both audio and video simultaneously. The DisplayPort cable signals include a main link with lanes 0-3, which are doubly terminated differential pairs, and an auxiliary or AUX channel, as well as a hot plug detect signal. The AUX channel uses one voltage peak-to-peak differential signal that is alternating current (AC) coupled along a bidirectional signal path. The AUX channel may be used for the initial handshake establishing the main link between source and sink devices. Further, the source device (in this case of display), uses the AUX channel to check the validity and status of the main link and also uses the AUX channel to modify the main link. As a result, the AUX channel may be used to establish and maintain the main link connection between the display device and the host.

The DisplayPort interface has a physical layer connection and an AC-coupled voltage-differential interface. The auxiliary channel is half duplex and bidirectional link and is commonly used for command and control functions sent across the interface.

In a conventional DisplayPort architecture, the DisplayPort configuration data (DPCD) describes the receiver's capabilities and stores the display's connection status. The extended display identification data (EDID) provides the source device with information about the display's capabilities once it is connected. Link and stream policy makers manage the link and the screen respectively. A link service discovers, configures, and maintains the link with devices it connects to using the DPCD via the auxiliary channel.

When hot plugging is detected, the source device reads capabilities of the display by way of the DPCD and configures the link using link training. In link training, a correct number of lanes are enabled at the correct link rate via handshake between the DisplayPort transmitter (usually the display) and the receiver over the auxiliary channel. Once link training has been completed during normal operation, the display uses the hot plug lane to detect changes.

The default AUX mode is one Megabit per second (Mbps) transfer rate in either direction that is Manchester encoded. The fast AUX mode, defined in the DisplayPort 1.2 standard, is 720 Mbps transfer rate in either direction, 8B/10B encoded, including link training. The standard AUX transport format is defined in the DisplayPort 1.1a standard to be in Manchester transport format, 1 Mbps first transfer of 16 data bytes maximum and capable of establishing 200 Kbps full duplex links. The fast AUX transport format, defined in DisplayPort 1.2, is 720 Mbps first transfer that is equal to 64/1024 data bytes maximum and capable of establishing full 200 Mbps full duplex link.

The AUX is first used by the source to discover the sink capabilities. It determines the display rendering capabilities and preferences by reading the display EDID using a special inter-integrated circuit (I2C) over AUX protocol. The AUX is used to maintain the link. A sink can notify the source if main link data corruption has occurred. Data and symbol lock and optional error correction code can be used to monitor the link's integrity.

In one embodiment, a universal serial bus (USB) compatible protocol may be used to send the data via an AUX channel port across the extended DisplayPort AUX channel 20 to a display controller 24. In turn, the display controller 24 which may be part of a central processing unit 22 and the whole system may send the data on to hardware reserved memory 34 within the host memory 32. The hardware reserved memory 34 (sometimes called stolen memory) is memory which is inaccessible to the operating system and is only accessible through an auxiliary processor such as a graphics processor 26. In one embodiment, the graphics processor 26 and central processor 22 are integrated in one integrated circuit but they may also be separate integrated circuits. The graphics processor and central processing unit may be part of a system on a chip in one embodiment.

A touch processing module 28 of the graphics processor 26 may communicate with the hardware reserved memory 34 and actually perform the touch engine processing which involves converting the signal received by the touch screen into actual input command (i.e. select icon X). Since the graphics processor 26 is necessary anyway, no additional hardware is needed. In addition, the graphics engine can also offload and schedule the touch engine processing to the general graphics processing unit. In still another embodiment a general purpose graphics processing unit application can implement the touch algorithms for example using OpenCL or other general purpose graphics processing unit languages.

For the operating system, a universal serial bus Human Interface Device (HID) class driver or a display driver may handle reporting the HID packets to the operating system, for example through a virtual HID driver. In some embodiments no extra cables may be needed for laptop computers that must go through the hinge. Suitable host devices can include cellular telephones, laptop computers, tablet computers, game devices to mention a few examples. In some embodiments since there is no chipset dependency, the solution is applicable to all different types of devices. In one embodiment, the operating system interface to an HID class driver may be unchanged and can be part of the graphic display drive for the operating system.

The touch processing that can be offloaded to the host includes one or more of taking the raw data from the TCON and converting it to coordinates, converting those coordinates into a screen position, determining what object was displayed at those coordinates at a particular time and determining what selection option was displayed on the screen, as well as, in some cases, actually implementing that selection option. Thus, the processing can convert coordinates to screen objects displayed at particular times and can convert those selections into user input commands understandable by the operating system. These transformations may involve transformations conventionally handled, for other purposes, by graphics processors, making execution of these operations by the graphics processor advantageous in many cases, in addition to the cost savings achievable by offloading processing tasks from the display to an existing hardware device in the host.

The digital touch processing algorithms run on the graphics processor are similar to image processing algorithms already run on the graphics processor. The touch and image processing may involve Fourier transforms and other computer intensive algorithms that may be better suited to execution by the graphics processor. Moreover, the graphic processor usually is available to run other tasks. The graphics processor may have the ability to process 10 finger touch image data.

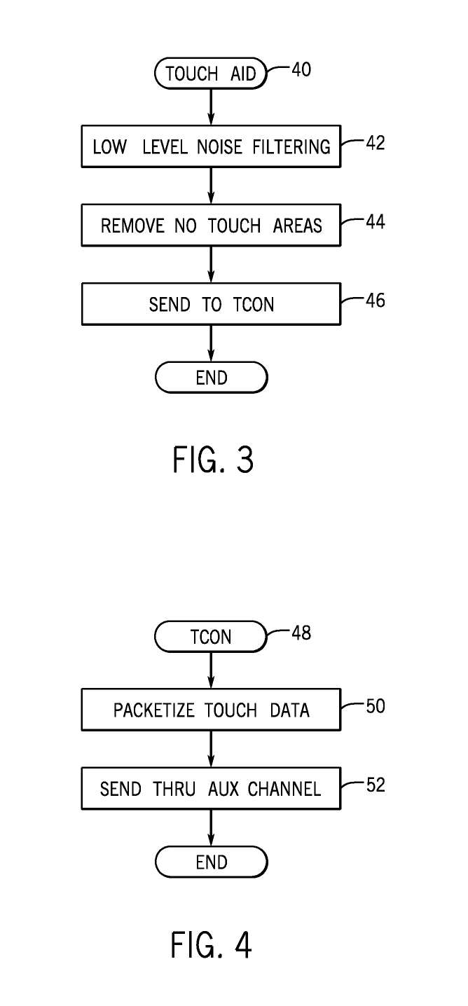

A sequence 40 shown in FIG. 3 may be implemented in software, firmware and/or hardware. In software and firmware embodiments it may be implemented by computer executed instructions stored in one or more non-transitory computer readable media such as magnetic, optical or semiconductor storages.

The touch analog to digital sequence 40 may be implemented for example in the touch A/D 18 shown in FIGS. 1 and 2. The sequence begins with a low level noise filtering as indicated in block 42. This may be more basic filtering which may be followed subsequently by more detailed remote filtering by the graphics engine 26, for example. The purpose of the low level filtering may be to reduce the bandwidth of the signal that is transmitted across the AUX channel. Similarly data from screen areas without touch sensors may be removed as indicated in block 44 for the same reason. Then the touch commands, which are basically raw commands, are sent on to the TCON as indicated in block 46.

The sequence 48 for implementation in the TCON may use software, firmware and/or hardware. In software and firmware embodiments it may use computer implemented instructions stored in one or more non-transitory computer readable media such as magnetic, optical or semiconductor storages.

A sequence 48 may begin by packetizing the touch data as indicated in block 50. The touch data may be packetized in a form compatible with the AUX or fast AUX channel in some embodiments. Then the data is sent over the AUX or fast AUX channel as indicated in block 52.

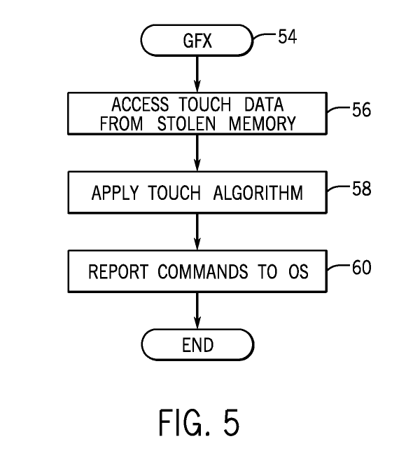

A sequence 54 shown in FIG. 5 may be implemented in software, firmware and/or hardware. In one embodiment, it may be implemented by a graphics processor but in other embodiments it may be implemented by other auxiliary processors. In software and firmware embodiments, it may be implemented by computer executed instructions stored in one or more non-transitory computer readable media such as magnetic, optical, or semiconductor storages.

The sequence 54 begins by accessing touch data from hardware reserved memory as indicated in block 56. Then the touch algorithm is applied and executed as indicated in block 58. The deciphered commands are then forwarded to the operating system as indicated in block 60.

The following clauses and/or examples pertain to further embodiments:

One example embodiment may be a method comprising receiving touch input signals from a touch screen over a AUX channel, and processing the received signals in a host based processor. The method may also include storing the received signals in hardware reserved memory on the host. The method may also include processing said signals in a graphics engine. The method may also include packetizing said signals on the touch screen. The method may also include filtering said signals for noise and for data from screen areas without touch sensors. The method may also include receiving said signals in a display controller on the host. The method may also include transferring said signals from said controller to hardware reserved memory.

Another example may be at least one computer readable medium storing instructions for execution by a processor to perform a sequence comprising receiving touch input signals over a AUX channel and processing the received signals in a host based processor. The medium may include said sequence including storing the received signals in hardware reserved memory on the host. The medium may include said sequence including processing said signals in a graphics engine. The medium may include said sequence including packetizing said signals on the touch screen. The medium may include said sequence including filtering said signals for noise and for data from screen areas without touch sensors. The medium may include said sequence including receiving said signals in a display controller on the host. The medium may include said sequence including transferring said signals from said controller to hardware reserved memory.

In another example embodiment may be an apparatus comprising a processor to receive touch input signals over an AUX channel and a memory coupled to said processor. The apparatus may include wherein said memory is a hardware reserved memory. The apparatus may include wherein said processor is a graphics processor. The apparatus may include a display controller to receive said signals. The apparatus may include a hardware reserved memory, said controller to transfer said signals to said hardware reserved memory.

In still another example embodiment may be an apparatus comprising an AUX channel port, a touch analog to digital converter, and a touch controller to packetize signals from said converter and to send them to a host through said port. The apparatus may include wherein said converter to filter non-touch screen areas. The apparatus may include wherein said converter to filter noise.

References throughout this specification to “one embodiment” or “an embodiment” mean that a particular feature, structure, or characteristic described in connection with the embodiment is included in at least one implementation encompassed within the present disclosure. Thus, appearances of the phrase “one embodiment” or “in an embodiment” are not necessarily referring to the same embodiment. Furthermore, the particular features, structures, or characteristics may be instituted in other suitable forms other than the particular embodiment illustrated and all such forms may be encompassed within the claims of the present application.

While a limited number of embodiments have been described, those skilled in the art will appreciate numerous modifications and variations therefrom. It is intended that the appended claims cover all such modifications and variations as fall within the true spirit and scope of this disclosure.

What is claimed is:

1. A method comprising:
receiving touch input signals from a touch screen over a AUX channel; and
processing the received signals in a host based processor.

2. The method of claim 1 including storing the received signals in hardware reserved memory on the host.

3. The method of claim 1 including processing said signals in a graphics engine.

4. The method of claim 1 including packetizing said signals on the touch screen.

5. The method of claim 4 including filtering said signals for noise and for data from screen areas without touch sensors.

6. The method of claim 1 including receiving said signals in a display controller on the host.

7. The method of claim 6 including transferring said signals from said controller to hardware reserved memory.

8. At least one computer readable medium storing instructions for execution by a processor to perform a sequence comprising:
receiving touch input signals over a AUX channel; and
processing the received signals in a host based processor.

9. The medium of claim 8, said sequence including storing the received signals in hardware reserved memory on the host.

10. The medium of claim 8, said sequence including processing said signals in a graphics engine.

11. The medium of claim 8, said sequence including packetizing said signals on the touch screen.

12. The medium of claim 8, said sequence including filtering said signals for noise and for data from screen areas without touch sensors.

13. The medium of claim 8, said sequence including receiving said signals in a display controller on the host.

14. The medium of claim 8, said sequence including transferring said signals from said controller to hardware reserved memory.

15. An apparatus comprising:
a processor to receive touch input signals over an AUX channel; and
a memory coupled to said processor.

16. The apparatus of claim 15 wherein said memory is a hardware reserved memory.

17. The apparatus of claim 15 wherein said processor is a graphics processor.

18. The apparatus of claim 15 including a display controller to receive said signals.

19. The apparatus of claim 18 including a hardware reserved memory, said controller to transfer said signals to said hardware reserved memory.

20. An apparatus comprising:
an AUX channel port;
a touch analog to digital converter; and
a touch controller to packetize signals from said converter and to send them to a host through said port.

21. The apparatus of claim 20 wherein said converter to filter non-touch screen areas.

22. The apparatus of claim 20 wherein said converter to filter noise.
